(19) United States
(12) Patent Application Publication
(10) Pub. No.: US 2005/0129159 A1
(43) Pub. Date: Jun. 16, 2005

(54) METHOD AND APPARATUS FOR COMPRESSING A BOSE-EINSTEIN CONDENSATE OF ATOMS

(75) Inventor: Herzel Laor, Boulder, CO (US)

Correspondence Address: KILPATRICK STOCKTON LLP, 607 14TH STREET, N.W., WASHINGTON, DC, 20005, US

(73) Assignee: Condensate Energy LLC, Boulder, CO (US)

(21) Appl. No.: 09/301,989

(22) Filed: Apr. 29, 1999

(51) Int. Cl. G21B 1/00

(52) U.S. Cl. 376/100

(57) ABSTRACT

Abstract of the Disclosure

A Bose-Einstein condensate (102) of atoms is compressed and/or rapidly de-condensed in a reaction chamber (104) by a beam (109) in order to achieve nuclear fusion. A pre-formed Bose-Einstein condensate of atoms may be introduced into the reaction chamber (104), or the constituent atoms of the Bose-Einstein condensate may be introduced into the reaction chamber (104) with formation of the Bose-Einstein condensate from the constituent atoms occurring subsequently inside the reaction chamber (104). The constituent atoms of the Bose-Einstein condensate may be bosons, Fermions or both. The beam (109) is directed at and focused on the Bose-Einstein condensate so as to maximize the total compression of the Bose-Einstein condensate. Upon de-condensing, the Bose-Einstein condensate atoms fuse, releasing substantial amounts of energy. This energy is harnessed and used to drive a turbine (120) to run a generator (122).

### Detailed Description of the Invention

### FIELD OF THE INVENTION

The present invention relates in general to a method and apparatus for producing energy by fusing the nuclei of two or more atoms. In particular, the invention relates to using a Bose-Einstein condensate of atoms as fuel for a nuclear fusion reaction in which a beam is used to compress or de-condense the Bose-Einstein condensate of atoms, thereby fusing the atoms of the Bose-Einstein condensate. The invention has the advantage of allowing for fusing atoms by tunneling through the extremely high potential energy barrier which must be overcome in other types of nuclear fusion reactions.

### BACKGROUND OF THE INVENTION

There is an interest in generating energy from nuclear fusion based on the vast amount of energy released from nuclear fusion reactions, the substantially limitless supply of fuel available for nuclear fusion reactions, and the positive environmental impact possible from abandoning traditional energy sources in favor of nuclear fusion reactions. Nuclear fusion occurs naturally in stars such as the Sun, where intense heat and pressure cause the nuclei of lighter elements to fuse together, forming heavier elements. Scientists have encountered difficulty in achieving nuclear fusion in the past because of the prohibitively high temperatures and pressures involved in nuclear fusion reactions due to the extremely high potential energy barrier which must be overcome before nuclear fusion occurs. Because nuclear fusion requires the co-location of two or more atoms, the difficulty results from the repulsive force between the atoms’ positively charged nuclei. The force required to overcome this repulsion and bring the atoms together varies proportionally to the inverse square of the distance between the atoms’ nuclei. Thus, as nuclear fusion is approached, the requisite force increases rapidly.

Several approaches to nuclear fusion have been proposed, including inertial confinement fusion and magnetic confinement fusion. Inertial confinement fusion involves a reaction wherein fuel is held together by its own inertia at a high enough temperature and pressure and for a long enough time for fusion to occur. The typical fuel in inertial confinement fusion experiments has included deuterium and tritium. Magnetic confinement fusion involves a reaction wherein fuel is held together by magnetic forces at a high enough temperature and pressure and for a long enough time for fusion to occur. As in inertial confinement fusion, magnetic confinement fusion also uses a fuel including deuterium and tritium. While these approaches have led to many attempts to create nuclear fusion, it is apparent that none of these methods have been fully effective for providing a commercially viable energy alternative.

### SUMMARY OF THE INVENTION

The present invention is directed to a method and apparatus for compressing or de-condensing a Bose-Einstein condensate of atoms in order to achieve nuclear fusion. This is readily distinguished -from conventional inertial confinement approaches. Conventionally, inertial confinement nuclear fusion occurs when a fuel source is confined by its own inertia at a high enough temperature and pressure and for a long enough time so as to effect nuclear fusion reactions. It has been recognized that a major obstacle to inertial confinement nuclear fusion involves overcoming the Coulomb electrical potential energy barrier. To overcome this repulsive force, a very high kinetic energy is required in conventional approaches. This high kinetic energy requirement, in turn, mandates the extremely high temperatures and pressures which have proved difficult to create in a laboratory setting. Instead of overcoming the potential energy barrier, the present invention is directed to a method and apparatus for tunneling through or avoiding the potential energy barrier.

While traditional approaches to inertial confinement nuclear fusion have been restricted mainly to the use of plasmas as sources of fuel, the present invention teaches the use of a fifth state of matter, a Bose-Einstein condensate. First suggested over fifty years ago by Satyendra Nath Bose and Albert Einstein, Super Fluid ⁴He was achieved in the 1930’s and Super Fluid 4He was achieved in the 1980’s. More recently, a condensate of gaseous material was made by E.A. Cornell and C.E. Wieman in June, 1995, and a gaseous condensate of 109 Hydrogen atoms was made by D.G. Fried et al. in June 1998. The Bose-Einstein condensate state generally occurs at very low temperatures. In such a Bose-Einstein condensate, most, if not all, atoms have overlapping wavefunctions and exhibit united quantum mechanical behavior. The present inventor has recognized that one way of tunneling through or avoiding the potential energy barrier is to find a state where wavefunctions of atoms overlap so as to be co-located.

Accordingly, the present invention involves a method and apparatus for providing a condensate including atoms having an overlapping wave function and exposing the condensate to a source of energy so that at least some of the co-located atoms fuse thereby releasing energy. The condensate may be comprised of bosons or paired fermions. The source of energy, in particular embodiments, is one or more high energy beams that may be focused on the condensate to maximize the intensity of the energy. The mechanism for achieving fusion may involve applying a compressive force sufficient to achieve fusion and/or rapidly de-compressing the atoms of the condensate causing fusion because of the affinity of the atoms of the bosons or fermion pairs. The resulting fusion energy can be used for propulsion or otherwise harnessed. In the latter regard, an energy flux from a chamber in which the fusion reaction occurs (e.g., heat, kinetic energy of the expelled reaction product) can be captured in any suitable way such as via heat exchangers, turbine generators, etc.

According to one aspect of the invention, a method is provided for compressing a Bose-Einstein condensate of atoms. The method involves providing a Bose-Einstein condensate of atoms and applying a compressive force so as to compress the Bose-Einstein condensate. The condensate is preferably a Bose-Einstein condensate of atoms. The atoms may be bosons, fermions arranged in Cooper Pairs, or fermions in other arrangements. In one implementation, the atoms are ⁴He, as He forms Bose-Einstein condensates more readily than do other atoms. Alternatively, the atoms may be Supra Fluid ¹H₂ which forms a liquid condensate at achievable temperatures. Many other condensate materials are possible. A beam may be used to compress the Bose-Einstein condensate, allowing for tunneling of the potential energy barrier upon de-condensing of the Bose-Einstein condensate. The beam may be, for example, a beam of electromagnetic energy or a beam of material. Viable sources for producing the compressive energy include an electron beam, a particle beam, a radio frequency energy beam, a high energy laser beam, an x-ray beam, or light. Preferably, the beam is a high energy laser beam capable of emitting high speed pulses of energy, such as a femto-second (or faster) laser beam, The high speed energy pulses allow for compression of transient byproducts of prior compression reactions. The beam is directed at the Bose-Einstein condensate from any direction, with the preferred embodiment including stimulation from at least two opposed directions for improved compression.

According to a further aspect of the invention, an apparatus is provided for compression of a Bose-Einstein condensate of atoms. The apparatus includes a system for introducing a Bose-Einstein condensate of atoms into a reaction chamber, a system for compressing the Bose-Einstein condensate in the reaction chamber, and a system for harnessing the reaction product of the compression of the Bose-Einstein condensate. The system for introducing the Bose-Einstein condensate may involve a mechanism for injecting a preformed Bose-Einstein condensate into the reaction chamber, or for injecting atoms into the reaction chamber and creating the Bose-Einstein condensate from the atoms inside the reaction chamber. The condensate comprises a Bose-Einstein condensate of atoms. The atoms may be, for example, bosons, fermions arranged in Cooper Pairs, or fermions in other arrangements. In one implementation, the atoms will be 4He. The Bose-Einstein condensate may be introduced into the reaction chamber via a receptacle which contains the Bose-Einstein condensate, This receptacle may be, for example, small plastic sphere capable of containing a fusionable amount of Bose-Einstein condensate.

In one embodiment, a beam for applying a compressive force is used to compress the Bose-Einstein condensate, allowing for tunneling of the potential energy barrier upon de-condensing of the Bose-Einstein condensate. As discussed above, the beam may be comprise a beam of electromagnetic energy or a beam of material. The beam is directed at the Bose-Einstein condensate from any direction, with the preferred embodiment including stimulation from at least two directions. The apparatus of this embodiment may further include a mechanism for focusing the beam at the Bose-Einstein condensate. Various types of focusing mechanisms, including lenses and mirrors, as well as self-focusing and electromagnetic focusing systems, or a combination thereof may be employed. A window may be utilized to facilitate entry of the beam into the reaction chamber. In one embodiment, the window includes a material which is capable of withstanding the effects of nuclear fusion reactions in the reaction chamber, such as, for example, sapphire or diamond. The apparatus may further include a shield for shielding the area adjacent to the reaction chamber. In one embodiment, a radiation shield is utilized so as to prevent the escape of nuclear fusion reaction output, including harmful gamma-ray radiation.

According to a still further aspect of the invention, an apparatus for generating energy includes a system for using a Bose-Einstein condensate of atoms as fuel for a nuclear fusion reactor, and a system for harnessing energy of the resulting nuclear fusion reactions. In one embodiment, a reaction chamber is at least partially surrounded by an insulating material, and the harnessing system includes a system for exchanging heat produced by the reaction output with the insulating material. Alternatively, the reaction product of the compression of the Bose-Einstein condensate to drive a transformer device for harnessing the reaction product of the compression of the Bose-Einstein condensate. This transformer device may include, for example, a reaction motor or a turbine. The transformer device may be driven directly by reaction product and/or an intermediate substance may be employed. In this regard, in one embodiment, the harnessing system uses the reaction product of the compression of the Bose-Einstein condensate to heat another substance, and then uses the heated substance to generate usable energy. This associated procedure may involve heating a fluid and then using the resulting steam to run a turbine to power a generator. In another embodiment, the energy harnessing system uses the reaction product of the compression of the Bose-Einstein condensate to directly drive a turbine to power a generator. In yet another embodiment, the harnessing system uses the reaction product of the compression of the Bose-Einstein condensate combined with another substance for transforming the reaction product to provide energy. For example, this procedure may involve injecting water into the reaction product and using the water-condensate mixture to drive a turbine to power a generator, or as a direct propulsion system for devices such as a rocket.

The present invention thus provides nuclear fusion reactions via the compression of a Bose-Einstein condensate of atoms such as via a compressive beam or beams. The invention thus allows for the use of a Bose-Einstein condensate of atoms as fuel for nuclear fusion. Moreover, the invention permits nuclear fusion reactions via tunneling of the potential energy barrier upon de-condensing of the compressed Bose-Einstein condensate of atoms, thus substantially avoiding the need to overcome the barrier.

### BRIEF DESCRIPTION OF THE DRAWINGS

For a more complete understanding of the present invention, and further advantages thereof, reference is now made to the following detailed description taken in conjunction with the drawings in which:

Fig. 1 is a cut-away view of an apparatus for compressing a Bose-Einstein condensate of atoms in order to achieve nuclear fusion in accordance with the present invention;

Fig. 2 is a cut-away view of one embodiment of an introduction system for introducing a Bose-Einstein condensate of atoms into a reaction chamber in accordance with the present invention;

Fig. 3 is a cut-away view of one embodiment of a focusing system for focusing a beam on the Bose-Einstein condensate of atoms with lenses in accordance with the present invention;

Fig. 4 is a cut-away view of one embodiment of a focusing system for focusing a beam on the Bose-Einstein condensate of atoms with mirrors in accordance with the present invention;

Fig. 5 is a flowchart for a method for compressing a Bose-Einstein condensate of atoms in order to achieve nuclear fusion in accordance with the present invention;

Fig. 6 is a cut-away view of one embodiment of a system for injecting a substance into the fusion reaction product in accordance with the present invention.

### DETAILED DESCRIPTION

The present invention relates to a method and apparatus for compressing or rapidly de-condensing a Bose-Einstein condensate of atoms in order to achieve nuclear fusion. According to both the method and the apparatus, a Bose-Einstein condensate of atoms is fused to release appreciable amounts of energy. The method and apparatus for compressing a Bose-Einstein condensate of atoms may be useful in numerous applications, especially in certain energy production and propulsion applications.

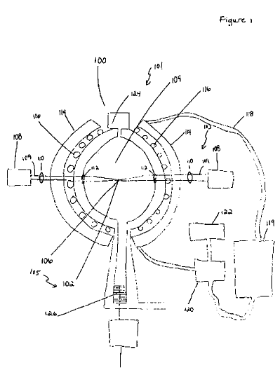

Fig. 1 shows a cut-away view of an apparatus 100 for compressing/de-condensing a Bose-Einstein condensate of atoms in order to achieve nuclear fusion. The apparatus 100 generally includes an introduction system 101, a compression and/or de-condensing system 103 (hereinafter “compression system”), and a harnessing system 105. The introduction system 101 involves either forming a Bose-Einstein condensate 102 in a reaction chamber 104 or, as illustrated, forming the Bose-Einstein condensate 102 outside the reaction chamber 1 04, e.g., in a preparation chamber 124 and thereafter introducing the Bose-Einstein condensate 102 into the reaction chamber 104. The Bose-Einstein condensate 102 may be a Bose-Einstein condensate containing either bosons or fermions or both.

It will be appreciated that various considerations are taken into account in selecting the exact composition of the Bose-Einstein condensate, including the availability of the Bose-Einstein condensate constituents, the ease of creating a Bose-Einstein condensate from certain constituents, the tendency of the Bose-Einstein condensate constituents to release harmful output particles, and the tendency of the Bose-Einstein condensate constituents to fuse together. Composition possibilities for the Bose-Einstein condensate constituents include bosons, fermions arranged in Cooper Pairs, and fermions in other arrangements. A boson is a particle with an even number of protons and an even number of neutrons. Fermions are particles that do not have even protons and neutrons but which, in certain pairings, may function in a manner similar to bosons for present purposes. In fusing bosons, for example, it is known that ⁴He atoms readily form Bose-Einstein condensates. However, when two ⁴He atoms fuse, the resulting ⁸Be isotope is unstable, with a lifetime on the order of 10⁻¹⁵ seconds. Also, the nuclear fusion of two ⁴He atoms is endothermic, so to create an energy-producing process, an additional ⁴He atom must be fused immediately with the unstable ⁸Be atom to create ¹²C. This second reaction produces substantial energy and emits a gamma ray.

In fusing Fermions, it is known that two Fermions may join to become a Cooper Pair, which behaves as a boson. Using Fermions arranged in Cooper Pairs as Bose-Einstein condensate constituents may have the advantage of producing a higher yield of fused atoms, if there is a greater chance of nuclear fusion of the members of a Cooper Pair into one atom. Additionally, the formation of a Bose-Einstein condensate of ¹H atoms is possible. Because ¹H is the most abundant element, this may provide a very available source of energy. Possible Boson or Cooper Pair Bose-Einstein condensate materials and reactions include: ¹H + ¹H ( ²D + e⁺ + 1.42 MeV ²D + ²D ( n + ³He + 3.2 MeV ³He + ³He ( gamma ray + ⁶Be + 11.5 MeV; ⁶Be ( ²D+ ⁴He + 12.8 MeV ⁷Li + ⁷Li ( ¹⁴C + energy ⁶Li + ⁶Li ( ¹²C + energy ¹²C + ¹²C ( ²⁴Mg + energy ( ²⁰Ne + ⁴He + energy OR ( ²³Na + ¹H + energy ¹⁶O + ¹⁶O ( ³²S + energy ²⁰Ne + ²⁰Ne ( ⁴⁰Ca + energy ⁴He + ⁴He + ⁴He ( ¹²C + energy and so on.

The formation of a Bose-Einstein condensate of dissimilar elements is also possible, where the two constituent elements create a boson pair. This type of formation may indeed enable a variety of Bose-Einstein condensate materials. Possible dissimilar atom reactions include: ¹H + ⁷Li ( gamma ray + ⁸B + 17 MeV ¹H + ⁹Be ( gamma ray + ¹⁰B + 6.6 MeV ¹H + ¹¹B ( gamma ray + ¹²C + 16 MeV ²D + ⁴He ( gamma ray + ⁶Li + 1.5 MeV ²D + ⁶Li ( gamma ray + ⁸Be + 22 MeV; ⁸Be ( 2 ⁴He + 22 MeV ²D + ¹⁰B ( n + ¹¹B + e⁺ + 6.6 MeV ³T + ³He ( gamma ray +⁶Li + 15.8 MeV ³T + ⁷Be ( n + p + 2 ⁴He + 10.5 MeV ³He + ⁷Li ( gamma ray + ¹⁰B + 17.8 MeV ³He + ⁹Be ( 3 ⁴He + 12 MeV ³He + ¹¹B ( p + ¹³C + 13 MeV ⁴He + ⁶Li ( gamma ray +¹⁰B + 4.4 MeV ⁴He +¹⁰B ( n + e⁺ + ¹³C + 2.7 MeV and so on.

Another possible condensate material is super-fluid ¹H₂. Under appropriate conditions, it is believed that this material can form a liquid condensate at reasonably achievable temperatures. Such a liquid condensate may allow for more atoms in the fusion reaction than gas condensates, and having the atoms nearer to each other in such a liquid condensate compared to gas may make the reaction more efficient.

In considering the various reaction possibilities, it should be noted that reactions with free neutrons in the reaction product are less desirable since the free neutrons may deteriorate the materials of the reaction chamber.

The introduction system 101 may further involve providing the Bose-Einstein condensate in a receptacle 106, such as a small plastic sphere. Such a receptacle would have the advantage of allowing a known amount of Bose-Einstein condensate 102 to be located at a fixed point in the reaction chamber 104.

The compression system 103 allows for the compression and/or rapid de-condensing of the Bose-Einstein condensate 102 as required to reduce the physical size of the Bose-Einstein condensate 102 or otherwise increase the chance of nuclear fusion of Bose-Einstein condensate atoms upon de-condensing of the Bose-Einstein condensate 102. The illustrated compression system uses a beam source 108 to compress/de-condense the Bose-Einstein condensate 102, The beam source 108 may generate any one of an electron beam, a particle beam, a beam of material (the same as or different from the condensate material), a radio frequency energy beam, a high energy laser beam, a femto-second laser beam, an x-ray beam, or light. In one embodiment, the beam source 108 is selected for a particular nuclear fusion reaction so that the pulse length of the generated beam 109 is at least as short as the lifetime of the most transitory compression output particle. For example, in the reaction described above wherein two ⁴He atoms fuse, resulting in the unstable ⁸Be isotope whose lifetime is on the order of 1 x 10⁻¹⁵ seconds, the preferred beam 109 would have a pulse length of less than about 1 x 10⁻¹⁵ seconds so as to maximize the possibility of fusing the transitory ⁸Be isotope.

To compress/de-condense the Bose-Einstein condensate 102, the beam 109 is directed at the Bose-Einstein condensate 102. In one embodiment, the beam 108 is directed at the Bose-Einstein condensate 102 from one direction, using the inertia of the Bose-Einstein condensate 102 to compress the Bose-Einstein condensate 102. In a preferred embodiment, the beam 109 is directed at the Bose-Einstein condensate 102 from at least two opposing directions so as to maximize the total compression of the Bose-Einstein condensate 102.

The compression system 101 may further involve the use of a focusing system 110 to focus the beam 109 prior to directing the beam at the Bose-Einstein condensate 102. The beam 109 is focused by any one of at least one lens, at least one mirror, a self-focusing system, or an electromagnetic focusing system. Focusing of the beam 109 may be further facilitated by at least one window 112 which allows entry of the beam 109 into the reaction chamber 104. The window 112 is made of a material which is capable of withstanding conditions inside the reaction chamber, such as, for example, sapphire or diamond.

The harnessing system 105 allows for the harnessing of energy from of the reaction product of the compression of the Bose-Einstein condensate. The illustrated harnessing system 105 includes a shielding subsystem 114 to protect against the harmful effects of electromagnetic radiation produced in nuclear fusion reactions. For example, in the nuclear fusion reactions listed above, gamma rays and neutrons are emitted. The shielding subsystem 114, which may include, for example, a radiation shield, will reduce or eliminate the possibility that these harmful particles will escape from the reaction chamber 104. In a preferred embodiment, the shielding system 114 will include the use of materials, such as lead and concrete, which demonstrate an electromagnetic radiation blocking property.

The illustrated harnessing system 105 further includes a conversion system for converting the reaction product of the compression of the Bose-Einstein condensate to energy. The conversion system may involve using the reaction product of the compression in conjunction with a heat exchanger subsystem 116 including tubing 118 and a cooling element 119, to drive a turbine 120 to run a generator 122. In this regard, the tubing 118 may circulate a fluid that is heated by the reaction product. The fluid is subsequently treated by the cooling element 119 so as to reduce the temperature or corrosive intensity of the fluid between the reaction chamber interface and the cooling element, the heated fluid may be used to drive a turbine 126 to run a generator 128. Additionally or alternatively the conversion system may also use the physical reaction product (i.e., the material expelled from the reaction chamber upon a fusion reaction) to directly drive a turbine 126 to run a generator 128 or to beat an intermediate fluid, e.g., water/water vapor, which in turn drives the turbine 126.

In one embodiment, the introduction system 101 introduces a Bose-Einstein condensate comprised of ⁴He atoms into the reaction chamber 104 in a small plastic sphere receptacle 106. Two femto-second laser beams 109 are then focused with lenses 110 through windows 112, and are directed at the Bose-Einstein condensate 102 from substantially opposing directions. As nuclear fusion of the Bose-Einstein condensate atoms occurs, the harnessing system 105 converts the reaction product of the nuclear fusion to energy.

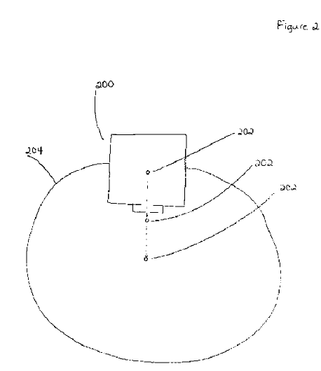

Fig. 2 shows a cut-away view of one embodiment of an introduction system 200 for introducing a Bose-Einstein condensate 202 into a reaction chamber 204. It will be appreciated that use of the introduction system 200 may include introducing a pre-formed Bose-Einstein condensate into the reaction chamber 204, or may include introducing constituent atoms into the reaction chamber 204 and thereafter forming the Bose-Einstein condensate 202 from the constituent atoms inside the reaction chamber 204. The Bose-Einstein condensate 202 may be propelled toward the reaction chamber 204 by gravitational force or another suitable force. It will be appreciated, however, that the types of such forces will vary in different embodiments of the invention. For example, laser beams may be used to optically trap and hold a Bose-Einstein condensate 202 in the reaction chamber 204 or to optically trap and transport a Bose-Einstein condensate 202 into the reaction chamber 204.

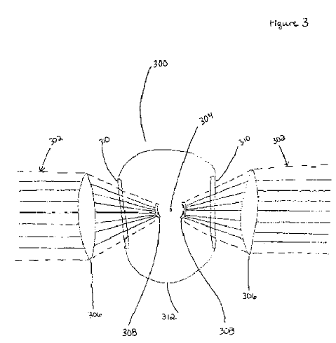

Fig. 3 shows a cut-away view of one embodiment of a focusing system 300 for focusing the beam 302 on the Bose-Einstein condensate 304 with lenses 306. The present embodiment shows the focusing by lenses 306 of two laser beams 302 on the Bose-Einstein condensate 304. The windows 310 facilitate the entry of the beam 302 into the reaction chamber 312. The illustrated embodiment shows the focusing of two laser beams 302 by lenses 306 into spherical wavefronts (indicated by arcs 308) for improved compression. However, the number and type of beams will vary in different embodiments of the invention. For example, one beam may be used relying on the inertia of the Bose-Einstein condensate material. Also, more than two beams may readily be used.

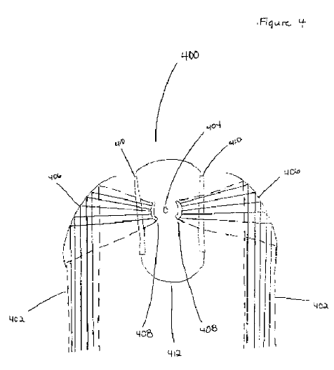

Fig. 4 shows a cut-away view of one embodiment of a focusing system 400 for focusing the beam 402 on the Bose-Einstein condensate 404 with mirrors 406. The present embodiment shows the focusing by mirrors 406 of two laser beams 402 into spherical wavefronts 408 for improved compression. The windows 410 facilitate the entry of the beam 402 into the reaction chamber 412. The illustrated embodiment shows the focusing of two laser beams 402 by mirrors 406, however, the number and type of beams will vary in different embodiments of the invention. The exhaust materials (physical reaction product) may be ejected out of the reaction chamber 412 to create thrust against the reaction chamber 412. Additional mass, such as water, may be added to the exhaust materials to create a larger thrust force. This thrust may be employed for propulsion, i.e., rocket propulsion. Alternatively, the ejected product may be used to run a turbine generator directly or via an intermediate material.

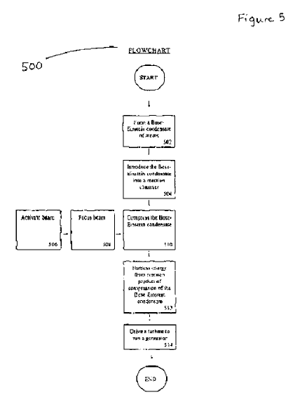

Fig. 5 shows a flowchart of a method 500 for compressing a Bose-Einstein condensate of atoms in order to achieve nuclear fusion. The illustrated process is initiated by forming (502) a Bose-Einstein condensate. The Bose-Einstein condensate may contain bosons, Fermions or both. As discussed in detail above in reference to Fig. 1, it will be appreciated that there are many considerations to take into account in selecting the constituent elements of the Bose-Einstein condensate. The variety of Bose-Einstein condensate constituent elements and associate reactions are discussed in detail above in reference to Fig. 1.

The process is then continued by introducing (504) the Bose-Einstein condensate into the reaction chamber. As discussed in detail above in reference to Fig. 2, the step of introducing the Bose-Einstein condensate into the reaction chamber may involve introducing a pre-formed Bose-Einstein condensate into the reaction chamber, or may include introducing constituent atoms into the reaction chamber and thereafter forming the Bose-Einstein condensate from the constituent atoms inside the reaction chamber. Also as discussed in detail above in reference to Fig. 2, various types of forces may be used in this step of introducing the Bose-Einstein condensate into the reaction chamber.

Another step in the process involves activating (506) a beam. This beam may include any one of an electron beam, a particle beam, a beam of material, a radio frequency energy beam, a high energy laser beam, a femto-second laser beam, an x-ray beam, or light. As discussed in detail above in reference to Fig. 1, the beam may be selected for a particular nuclear fusion reaction so that the pulse length of the beam has a time length on the same order of magnitude as the lifetime of the most transitory compression output particle.

The activating step may further involve focusing (508) the beam using at least one lens or mirror, and may include active components such as a self-focusing system (e.g., to move the lens or mirror to adjust focusing based on certain feedback such as power readings), or, for a charged beam of electromagnetic energy, an electromagnetic focusing system. Focusing of the beam may be facilitated by a window which allows entry of the beam into the reaction chamber. This window is made of a material which is substantially transparent to the beam and is capable of withstanding conditions inside the reaction chamber, such as, for example, sapphire or diamond, The next step in the process involves compressing (510) the Bose-Einstein condensate by using the beam to apply force on the Bose-Einstein condensate. In a preferred embodiment, the Bose-Einstein condensate is compressed by directing the beam at the Bose-Einstein condensate from at least two opposing directions so as to maximize to total compression of the Bose-Einstein condensate.

The process continues by harnessing (512) the energy from the reaction product of the compression of the Bose-Einstein condensate, This may be accomplished by driving (514) a turbine with the energy harnessed from the reaction product of the compression of the Bose-Einstein condensate to run a generator. In this regard, a turbine may be driven directly by the physical reaction product, by an intermediate fluid heated by the physical reaction product, or by an intermediate fluid heated by heat exchange with the reaction chamber and/or other energy emitted from the reaction chamber. As discussed in detail above in reference to Fig. 1, it will be appreciated that there are a variety of ways to harness the energy and to drive the turbine to run the generator.

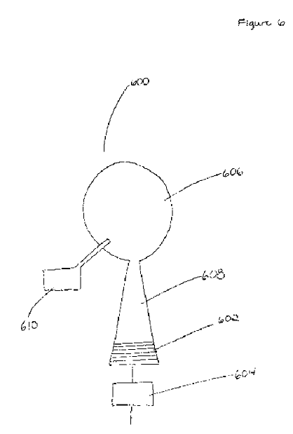

Fig. 6 shows a cut-away view of one embodiment of a system for injecting a substance (e.g., water or water vapor) into the reaction product of the compression 600 to form a mixture, and using the energy of the mixture as a means to drive a turbine 602 to run a generator 604. The system for injecting a substance into the reaction product of the compression 600 may comprise a nozzle for injecting 610 the substance directly into the reaction chamber 606, or into the exit conduit 608 from the reaction chamber 606. The embodiment in Fig. 6 depicts means for injecting 610 the substance directly into the reaction chamber 606. The turbine 602 and generator 604 are disposed at the end of the exit conduit 608 from the reaction chamber 606. It will be appreciated that the injected substance may increase the mass and the energy of the ejected stream which drives the turbine, thereby enhancing efficiency.

While various embodiments of the present invention have been described in detail, it is apparent that further modifications and adaptations of the invention will occur to those skilled in the art. However, it is to be expressly understood that such modifications and adaptations are within the spirit and scope of the present invention.

1. 1. A method for generating energy, comprising the steps of:
providing a Bose-Einstein condensate of atoms;
providing a beam for applying a compressive force; and
using said beam to compress said Bose-Einstein condensate wherein a resulting reaction provides energy that can be used for propulsion or otherwise harnessed.

2. 2. A method as set forth in Claim 1, wherein said step of providing a Bose-Einstein condensate comprises one of forming a Bose-Einstein condensate in a reaction chamber and forming a Bose-Einstein condensate in a preparation chamber and transporting said Bose-Einstein condensate into said reaction chamber.

3. 3. A method as set forth in Claim 2, wherein said step of forming a Bose-Einstein condensate comprises providing a multiplicity of bosons.

4. 4. A method as set forth in Claim 3, wherein said step of providing a multiplicity of bosons comprises providing ⁴He.

5. 5. A method as set forth in Claim 2, wherein said step of forming a Bose-Einstein condensate comprises providing a multiplicity of Fermions.

6. 6. A method as set forth in Claim 5, wherein said step of providing a multiplicity of Fermions comprises providing a multiplicity of Fermions arranged in a multiplicity of Cooper Pairs.

7. 7. A method as set forth in. Claim 1, wherein said step of using said beam comprises directing an electron beam at said Bose-Einstein condensate.

8. 8. A method as set forth in Claim 1, wherein said step of using said beam comprises directing a particle beam at said Bose-Einstein condensate.

9. 9. A method as set forth in Claim 1, wherein said step of using said beam comprises directing a beam of material at said Bose-Einstein condensate.

10. 10. A method as set forth in Claim 1, wherein said step of using said beam comprises directing a radio frequency energy beam at said Bose-Einstein condensate.

11. 11. A method as set forth in Claim 1, wherein said step of using said beam comprises directing a high energy laser beam at said Bose-Einstein condensate.

12. 12. A method as set forth in Claim 11, wherein said step of using said high energy laser beam comprises directing a femto-second laser beam at said Bose-Einstein condensate.

13. 13. A method as set forth in Claim 1, wherein said step of using said beam comprises directing an x-ray beam at said Bose-Einstein condensate.

14. 14. A method as set forth in Claim 1, wherein said step of using said beam comprises directing light at said Bose-Einstein condensate.

15. 15. A method as set forth in Claim 1, wherein said step of using comprises directing said beam at said Bose-Einstein condensate from at least two different directions.

16. 16. A method as set forth in Claim 15, wherein said beam comprises a laser beam.

17. 17. An apparatus for compressing a Bose-Einstein condensate comprising:
means for introducing a Bose-Einstein condensate of atoms into a reaction chamber;
means for compressing said Bose-Einstein condensate in said reaction chamber; and
means for harnessing a reaction product of said compression of said Bose-Einstein condensate.

18. 18. An apparatus as set forth in Claim 17, wherein said means for introducing comprises forming a Bose-Einstein condensate.

19. 19. An apparatus as set forth in Claim 18, wherein said Bose-Einstein condensate comprises a multiplicity of bosons.

20. 20. An apparatus as set forth in Claim 19, wherein said multiplicity of bosons comprises ⁴He.

21. 21. An apparatus as set forth in Claim 18, wherein said Bose-Einstein condensate comprises a multiplicity of Fermions.

22. 22. An apparatus as set forth in Claim 21, wherein said multiplicity of Fermions comprises Fermions arranged in Cooper Pairs.

23. 23. An apparatus as set .forth in Claim 17, wherein said means for introducing comprises providing a receptacle to contain said Bose-Einstein condensate.

24. 24. An apparatus as set forth in Claim 17, wherein said means for compressing comprises:
a beam source for generating a beam for applying a compressive force; and
means for using said beam to compress said Bose-Einstein condensate.

25. 25. An apparatus as set forth in Claim 24, wherein said beam source comprises means for transmitting an electron beam.

26. 26. An apparatus as set forth in Claim 24, wherein said beam source comprises means for transmitting a particle beam.

27. 27. An apparatus as set forth in Claim 24, wherein said beam source comprises means for transmitting a beam of material.

28. 28. An apparatus as set forth in Claim 24, wherein said beam source comprises means for transmitting a radio frequency energy beam.

29. 29. An apparatus as set forth in Claim 24, wherein said beam source comprises means for transmitting a high energy laser beam.

30. 30. An apparatus as set forth in Claim 29, wherein said means for transmitting a high energy laser beam comprises means for transmitting a femto-second laser beam.

31. 31. An apparatus as set forth in Claim 24, wherein said beam source comprises means for transmitting an x-ray beam.

32. 32. An apparatus as set forth in Claim 24, wherein said beam source comprises means for transmitting light.

33. 33. An apparatus as set forth in Claim 24, wherein said means for using comprises means for directing said beam at said Bose-Einstein condensate from at least two different directions.

34. 34. An apparatus as set forth in Claim 33, wherein said beam source comprises a laser beam.

35. 35. An apparatus as set forth in Claim 24, wherein said means for using comprises a focusing means .for focusing said beam on said Bose-Einstein condensate.

36. 36. An apparatus as set forth in Claim 35, wherein said focusing means comprises at least one lens.

37. 37. An apparatus as set forth in Claim 35, wherein said focusing means comprises at least one mirror.

38. 38. An apparatus as set forth in Claim 35, wherein said focusing means comprises an electromagnetic focusing means.

39. 39. An apparatus as set forth in Claim 17, further comprising a window into said reaction chamber formed from one of sapphire or diamond.

40. 40. An apparatus as set forth in Claim 17, wherein said means for harnessing comprises:
means for shielding an area adjacent to said reaction chamber from said reaction product of said compression;
means for converting said reaction product of said compression to energy.

41. 41. An apparatus as set forth in Claim 40, wherein said means for shielding comprises a radiation shield.

42. 42. An apparatus as set forth in Claim 40, wherein said means for converting comprises:
means for receiving heat based on said reaction product of said compression; and
means for transforming said heat to said energy.

43. 43. An apparatus as set forth in Claim 42, wherein said means for receiving heat comprises a heat exchanger including a fluid for receiving heat from said reaction product.

44. 44. An apparatus as set forth in Claim 40, wherein said means for converting comprises:
means for using said reaction product of said compression as a propellant.

45. 45. An apparatus as set forth in Claim 40, wherein said means for converting comprises:
means for using said reaction product of said compression to heat a substance;
means for transforming said heat in said substance to said energy.

46. 46. An apparatus as set forth in Claim 45, wherein said means for transforming comprises a heat exchanger for transferring heat to a drive medium for driving a power generator.

47. 47. An apparatus as set forth in Claim 40, wherein said means for converting comprises:
means for injecting a substance into said reaction product of said compression to form a mixture; and
means for using said mixture to generate power.

48. 48. A method for use in producing useable energy, comprising the steps of:
providing a condensate of atoms wherein at least some of the atoms have overlapping wave functions (“co-located atoms”);
exposing the condensate of atoms to a source of energy such that at least some of the co-located atoms fuse thereby releasing fusion energy; and
harnessing a portion of the fusion energy released by the fused co-located atoms.

49. 49. A method as set forth in Claim 48, wherein said step of providing comprises providing a Bose-Einstein condensate.

50. 50. A method as set forth in Claim 49, wherein said Bose-Einstein condensate comprises one of bosons and paired Fermions.

51. 51. A method as set forth in Claim 48, wherein said step of exposing comprises exposing the co-located atoms to energy sufficient to achieve fusion.

52. 52. A method as set forth in Claim 48, wherein said step of exposing comprises exposing the co-located atoms to energy sufficient to de-condense at least some of said co-located atoms so as to achieve fusion.

53. 53. A method as set forth in Claim 48, wherein said co-located atoms are fused in a reaction chamber 54 and said step of harnessing comprises using an energy flux from said reaction chamber.

54. 54. A method as set forth in Claim 53, wherein said step of using said energy flux comprises receiving heat from said reaction chamber.

55. 55. A method as set forth in Claim 53, wherein said step of using said energy flux comprises using a reaction product stream expelled from said reaction chamber.

56. 56. A method as set forth in Claim 55, wherein said reaction product stream is used for propulsion.

57. 57. A method as set forth in Claim 55, wherein an energy of said reaction product stream is used to run a power generator.

58. 58. A method as set forth in Claim 55, wherein said step of using a reaction product stream comprises contacting said reaction product with a supplemental material such that said stream includes said reaction product and said supplemental material.
